(19) United States
(12) Patent Application Publication
(10) Pub. No.: US 2008/0190861 A1
(43) Pub. Date: Aug. 14, 2008

(54) COMPOSITION AND METHOD FOR AGGLOMERATING SOLIDS IN SOLID-LIQUID SEPARATION PROCESSES

(76) Inventor: Merle L. Branning, Plano, IL (US)

Correspondence Address: Edward O. Yonter;Patent and Licensing Department, Nalco Company, 1601 West Diehl Road, Naperville, IL, 60563-1198, US

(21) Appl. No.: 11/674,804

(22) Filed: Feb. 14, 2007

(51) Int. Cl. C02F 1/52

(52) U.S. Cl. 210/728

(57) ABSTRACT

An effervescent chitosan-containing solid composition for agglomerating solids in and clarifying a slurry in a solid-liquid separation process or system, such as a mining pond, and a method of using the composition is described and claimed. The slurry contains water and solids. The composition includes chitosan, a solid acid, and a carbonate or a bicarbonate source. Optionally, the composition is formulated with an inert fluorescent tracer, to aid in dosing the composition to the slurry in the system. This clarification process causes solids to settle to the bottom of the pond, or otherwise aid in separating the solids from the aqueous phase, leaving the water less turbid than before the application of chitosan.

### TECHNICAL FIELD

This invention relates generally to a composition and method for agglomerating solids in solid-liquid separation processes. More specifically, the invention relates to a composition including environmentally friendly chitosan that agglomerates solids from mining and mineral operation pond systems having a slurry with water and mined solids. The invention has particular relevance to a combination of chitosan, an acid component, and a carbonate or bicarbonate source that is characterized by improving chitosan dissolution rates in aqueous systems.

### BACKGROUND

Pond systems are used in many industrial operations, such as mining of ores, minerals, and precious metals, certain chemical processing plants (e.g., production of clays, alumina, pigments, and paints), and some polishing operations (e.g., sheet metal and silicon wafers). A problem associated with pond systems is that dispersed solids cannot be separated completely by conventional sedimentation or filtration leading to problems including corrosion and scaling of equipment, loss of product values in the suspended solids, and low product quality due to poor solids removal. Additionally, fluids being discharged from a manufacturing plant to a public water system must meet local requirements and the water in the pond systems may need to be treated prior to discharge from a plant or if the water content of the slurry is to be recycled.

Many of these industrial processes, such as mining and mineral operations, include solid/liquid separation processes. Typically, a series of ponds (i.e., pond system) have slurries including water and mined solids at the end of mineral processing. Current industry practice is to add synthetic polymers to separate inorganic and organic solids from slurries to allow recycling or discharge of process water used in these operations. The polymers act to agglomerate mined solids to cause settling thus helping to clarify the slurry such that the mined solids are separated from the water.

The water may then be taken from the pond for either later use or addition/discharge to a natural body of water. Known synthetic polymers that are useful to clarify mining ponds include poly diallyldimethyl ammonium chloride (DADMAC), epichlorohydrin dimethylacrylate (EPT/DMA), polyaluminum chloride/calcium chloride (PAC/CaCl₂), and the like. For example, U.S. Pat. No. 6,203,711 B1 to Moffett discloses a method of using a combination of silica-based colloid and anionic polymer to aid in flocculating particulate material in aqueous streams from mining operations.

When the clarified water is discharged into the environment, however, it is desirable to employ environmentally friendly treatment methods. While much attention has been devoted to the general area of wastewater treatment and, more specifically treatment of municipal wastewaters, such treatment methods may not be effective for industrial processing wastewaters in terms of cost or providing acceptable water quality. Therefore, there is a need for an efficient, cost-effective system to clarify wastewater fluids present in inorganic and mineral processing.

Chitosan (a natural organic biodegradable polysaccharide) has been identified as an environmentally friendly treatment scheme. Although usually fed as a dilute solution or in the gel form, it would be more advantageous to feed it in the solid form. Its dissolution rate in solid form, however, is very low. If, for instance, the solubility rate could be increased (enhanced dissolution rate), the use of chitosan as an environmentally friendly pond treatment clarification aid could be made more effective and economical. Thus, there exists a continued need for a method to quickly disperse the ultimate treatment of chitosan in a given pond system to affect efficient solid/liquid separation. Additionally, the incorporation of fine silica or the like, can offer enhanced performance to this matrix by offering nucleation sites for the effective removal of hydrocarbons from a given pond system.

### SUMMARY

This invention accordingly provides a composition for dosing a solid-liquid separation system to agglomerate suspended solids in the system. In one embodiment, the solid-liquid separation system is a mining or mineral pond system. The composition includes a first component and a second component. The first component includes chitosan. The second component includes a solid acid and a carbonate source and/or a bicarbonate source in a ratio of about 1:4 to about 4:1. The ratio may be a weight ratio or a molar ratio.

In an embodiment, the composition is a dry blend of chitosan (first component) with an organic acid and a carbonate or bicarbonate (second component). The chitosan may be in any suitable form, such as pellet, flake, powder, the like, and combinations thereof, according to alternative embodiments. This dry blend is characterized by a synergistic effect of enhancing a dissolution rate of the chitosan in an aqueous system. Adjusting the ratio of the first component to the second component and/or the ratio of the organic acid to the carbonate or bicarbonate in the second component determines the rate of dissolution of the chitosan and thus controls the treating of liquid/solid separation processes. The effervescence (i.e., carbon dioxide gas release in solution) provides the dry chitosan a more effective surface area/water contact resulting in controllable and enhanced dissolution rates.

In an aspect, the invention includes a method of agglomerating solids in a solid-liquid separation system. In an embodiment, the system is a mining or mineral processing pond system. The method includes controllably dosing such a system with the chitosan-containing composition herein described. In an embodiment, the method includes adding an inert fluorescent tracer to the composition and using one or more fluorometers to detect a fluorescent signal of the inert fluorescent tracer. An amount of the fluorescent tracer that is present in the system is then determined and an amount of the chitosan present in the system based on the amount of the fluorescent tracer that is present in the system is calculated. According to an embodiment, the method includes adjusting the dose of the chitosan-containing composition to ensure a desired amount of chitosan is present in the system.

In an aspect, the clarified water from a mining pond or pond system can either be returned to the mine or to the mining processing plant for further use, or may be discharged into a natural body of water. “LC₅₀” is that concentration of a material in water that will be lethal to 50% of the test subjects when administered as a single exposure over a set, typically over a 1 to 4 hour time period. Chitosan has been reported to have an LC₅₀ for Daphnia of 463 mg/L and a LC₅₀ for Rainbow Trout of 155 mg/L. LC₅₀ information always has to be reported in units of mass per volume of water and also has to be reported relative to a specific test subject. These LC₅₀ results indicate that chitosan has been found to be of relative low toxicity to aquatic organisms. This is an especially valuable feature of the instant claimed invention in those instances where the chitosan travels with the clarified water into a natural body of water, rather than settling with the mined solids.

It is an advantage of the invention to provide a composition that enhances the dissolution rate of chitosan in an aqueous system.

It is another advantage of the invention to provide a biodegradable and environmentally friendly composition for agglomerating solids in a solid-liquid separation process, such as a mining and/or mineral operation pond system.

It is a further advantage of the invention is to provide an effervescent chitosan-containing composition that acts to stimulate mixing in stagnant application conditions.

Yet another advantage of the invention is to provide a method of controlling the dosage of a chitosan-containing composition in a solid-liquid separation process or system.

Additional features and advantages are described herein, and will be apparent from, the following Detailed Description and Examples.

### DETAILED DESCRIPTION

For purposes of this patent application, “mined solids” include any material removed from its original location on or in the ground. Thus mined solids typically contain the target material for the mine, such as coal, gold, silver, iron ore, bauxite, and potassium chloride, and may also contain unwanted rocks, soil, and other materials, such as wood, leaves, and grass. Mined solids can be transported with water to mining ponds at the mine itself. Also, mined solids can be transported with water to mining ponds at the mined solids processing plant.

It is contemplated that the composition and method herein described may be used in any solid-liquid separation process or system. Representative systems include woven and composite filter media, nonwoven filter media, membranes, clarification filtration, sedimenters, cake filters, centrifugal separations, pressure filtration, vacuum filtration, and the like. The invention is particularly suited for mining ponds that are used to hold slurries including water and mined solids, where sedimentation typically takes place upon addition of the described composition. Mining ponds can be formed out of naturally occurring bodies of water or they can be constructed on an “as needed” basis to process slurries comprising water and mined solids. The mining ponds formed out of naturally occurring bodies of water typically have natural water sources, such as rainwater or runoff from rain, to replenish the water in the pond. Constructed mining ponds typically have slurries pumped to the pond from the mine or a mined solids processing plant.

According to an embodiment, the invention is used in a pond system including only one pond. In another embodiment, the pond system includes a plurality of ponds. In an embodiment, the pond system includes a plurality of ponds and less than the plurality ponds is dosed with the composition. In a further embodiment, the pond system includes a plurality of ponds and each pond is dosed with the solid composition. In yet another embodiment, the pond system includes a plurality of ponds and the dose of the solid composition is individually adjusted for each pond.

In an embodiment, the invention is a solid composition including a chitosan material or component. The chitosan component may be native chitosan, modified chitosan, chitosan salts, and the like. In another embodiment the chitosan is chitosan lactate. Chitosan is a partially or fully deacetylated form of chitin (a naturally occurring polysaccharide of poly-D-glucosamine), which is the principal constituent of the shells of crustaceans, such as crabs, lobsters, and shrimp and many insects.

Chitosan is also described chemically as a deacylated derivative of chitin. Chitosan monomers have the formula C₆H₁₁NO₄, and each chitosan “unit” has a molecular weight of 161 atomic mass units (“a.m.u.”). Chitosan polymers typically have a molecular weight of about 3,000 a.m.u. to about 300,000 a.m.u. Chitosan can be made in liquid, dry, and gelatinous forms. The dry form is preferred for forming the solid composition of the invention. Besides being the most common naturally occurring polysaccharide (after cellulose), it is available commercially from a variety of different chemical supply companies. Commercially available chitosan and derivatives include those sold under the tradename “Chitosolv L” (available from Vanson, Inc., located in Redmond, Wash.). Other commercially available, as well as synthesized, chitosan products and modifications thereof can also be used for this invention.

Methods for the manufacture of pure chitosan are well known. Generally, chitin is milled into a powder and an organic acid, such as acetic acid, is added to demineralize the powder. Treatment with a base, such as sodium hydroxide, is added to remove proteins and lipids. Chitin deacetylation by treatment with concentrated base, such as 40 percent sodium hydroxide, follows. The formed chitosan product is washed with water until the desired pH is reached. Properties of aminopolyssaccharides, especially chitosan, relate to their polyelectrolyte and polyineric carbohydrate character.

Preferred chitosan materials have an average degree of deacetylation of more than 75%, preferably from 80% to about 100%, even more preferably from 90% to 100%, and most preferably from 95% to about 100%. The degree of deacetylation refers to the percentage of the amine groups that are deacetylated. This characteristic is directly related to the hydrogen bonding existing in this biopolymer, affecting its structure, solubility, and, ultimately, its reactivity. The degree of deacetylation can be determined by titration, dye adsorption, UV-VIS, IR, and NMR spectroscopy and influences the cationic properties of chitosan material.

The chitosan material is preferably provided as fine particles with less than about 1% of the particles having a diameter of greater than about 600 microns or 250 microns, or greater than about 100 microns, or greater than about 50 microns. Typically, preferred chitosan materials have an average molecular weight ranging from 1,000 to 10,000,000 and more preferably from 2,000 to 1,000,000.

In one embodiment, the chitosan can be combined with a siliceous material, such as dry silica, silica gel, and/or colloidal silica (CAS Registry No. 7631-86-9). In a further embodiment, the composition includes an effective amount of silica sol including those described in U.S. Pat. App. 2005-0234136 A1, or any other suitable siliceous material.

In an embodiment, the invention is a solid composition including a solid acid component. Representative acids include any acid in the solid phase, such as citric acid, tartaric acid, ascorbic acid, or any other suitable organic or other solid acid including biological acids. Carboxylic acids including benzoic, salicylic, propionic, and the like are also contemplated. Organic acids are preferred. Citric, ascorbic, and tartaric acids are most preferred. Any combination of such acids may be used for the solid composition of the invention.

In an embodiment, the invention is a solid composition including a carbonate or bicarbonate source. Preferably, it is a carbonate or bicarbonate having an alkali or alkaline earth metal counterion. Representative compounds include sodium carbonate, sodium bicarbonate, calcium carbonate, calcium bicarbonate, magnesium carbonate, magnesium bicarbonate, the like, and combinations thereof. Sodium carbonate and sodium bicarbonate are preferred.

In one embodiment, a solid admixture of chitosan, a solid acid component, and a carbonate or bicarbonate source is prepared. The admixture preferably includes about 5 to about 95 weight percent of chitosan. More preferably, the admixture includes about 10 to about 90 weight percent chitosan and even more preferably about 20 to about 80 weight percent chitosan. Most preferably, the admixture includes about 50 to about 80 weight percent chitosan. In an embodiment, the chitosan is a first component and the solid acid component and the carbonate or bicarbonate source is a second component of the admixture. Preferably, the admixture includes a ratio of about 1:4 to about 4:1 of the first component to the second component. More preferably, the ratio is about 1:2 to about 2:1 and most preferably is about 1:1. Any suitable ratio may be used and the ratio may be a molar ratio or a weight ratio. Preferably, it is a molar ratio. The second component is further characterized by enhancing a dissolution rate of the chitosan in an aqueous system. In an embodiment, the solid admixture is pressed into a pellet, as explained in more detail below.

It should be appreciated that methods of dosing the chitosan-containing composition enhances the efficacy of the chitosan-containing composition in clarifying slurries in solid-liquid separation processes. Controlled addition of the chitosan-containing composition to the slurry, such as in a mining pond is typically recommended. Such control is typically achieved by adjusting the component ratios or delivery method of the described composition. For those mined ponds where the source of the water is natural water, such as rain and runoff from rain, commercially available bait buckets, media socks, and any other commercially available means for slow delivery of the natural polymer to an aqueous system may be used. Other suitable delivery methods are also contemplated, including direct addition.

In the case of mining ponds, it has been discovered that placing a “bait bucket” or “media sock” of the chitosan-containing composition within the natural water feed stream to the mining pond, is a preferred technique for introducing the chitosan to the water. Such bait buckets and media socks are available from materials handling equipment companies. Furthermore, means for addition of the chitosan-containing composition to natural or constructed mining ponds can include pumps and pipes wherein the rate of chitosan introduction is adjusted by the flow rate of the pump and flow meters.

According to an embodiment, the solid-liquid separation system is dosed with an amount of the chitosan-containing composition effective to provide to the system about 0.01 pounds to about 100 pounds chitosan per ton dry solids. Preferably this amount is about 0.01 pounds to about 10 pounds. Most preferably the amount is about 0.01 pounds to about 1 pound.

Another embodiment of the invention includes incorporating one or more inert fluorescent tracers into the chitosan-containing composition or adding a known proportion of one or more fluorescent tracers to the pond system in conjunction with the composition, such as simultaneously or sequentially. Fluorometers are used to detect the fluorescent signal of the inert fluorescent tracer in the slurry in the pond to determine how much inert fluorescent tracer is present. This signal is then used to determine how much chitosan is present in the pond system. If desired, adjustments to the operating conditions of the mining pond can be made to ensure a desired amount of chitosan is present. “Inert fluorescent tracer” or like terms means a material which is capable of fluorescing while present in the water in the mining pond that is being treated with chitosan. The inert fluorescent tracer compound should not be appreciably affected by any other material present in the water of the mining pond, or by the temperature or temperature changes encountered in the mining pond.

Representative inert fluorescent tracers suitable for use with chitosan include the following:

1-deoxy-1-(3,4-dihydro-7,8-dimethyl-2,4-dioxobenzo[g]pteridin-10(2H)-yl)-D-ribitol, also known as Riboflavin or Vitamin B2 (CAS Registry No. 83-88-5);

fluorescein (CAS Registry No. 2321-07-5);

fluorescein, sodium salt (CAS Registry No. 518-47-8, aka Acid Yellow 73, Uranine);

2-anthracenesulfonic acid sodium salt (CAS Registry No. 16106-40-4);

1,5-anthracenedisulfonic acid (CAS Registry No. 61736-91-2) and salts thereof;

2,6-anthracenedisulfonic acid (CAS Registry No. 61736-95-6) and salts thereof;

1,8-anthracenedisulfonic acid (CAS Registry No. 61736-92-3) and salts thereof;

mono-, di-, or tri-sulfonated napthalenes, including but not limited to 1,5-naphthalenedisulfonic acid, disodium salt (hydrate) (CAS Registry No. 1655-29-4, aka 1,5-NDSA hydrate), 2-amino-1-naphthalenesulfonic acid (CAS Registry No. 81-16-3), 5-amino-2-naphthalenesulfonic acid (CAS Registry No. 119-79-9), 4-amino-3-hydroxy-1-naphthalenesulfon acid (CAS Registry No. 90-51-7), 6-amino-4-hydroxy-2-naphthalenesulfonic acid (CAS Registry No. 116-63-2), 7-amino-1,3-naphthalenesulfonic acid, potassium salt (CAS Registry No. 79873-35-1), 4-amino-5-hydroxy-2,7-naphthalenedisulfonic acid (CAS Registry No. 90-20-0), 5-dimethylamino-1-naphthalenesulfonic acid (CAS Registry No. 4272-77-9), 1-amino-4-naphthalene sulfonic acid (CAS Registry No. 84-86-6), 1-amino-7-naphthalene sulfonic acid (CAS Registry No. 119-28-8), and 2,6-naphthalenedicarboxylic acid, dipotassium salt (CAS Registry No. 2666-06-0); 3,4,9,10-perylenetetracarboxylic acid (CAS Registry No. 81-32-3);

C.I. Fluorescent Brightener 191, also known as, Phorwite CL (CAS Registry No. 12270-53-0);

C.I. Fluorescent Brightener 200, also known as Phorwite BKL (CAS Registry No. 61968-72-7);

benzenesulfonic acid, 2,2′-(1,2-ethenediyl)bis[5-(4-phenyl-2H-1,2,3-triazol-2-yl)-, dipotassium salt, also known as Phorwite BHC 766 (CAS Registry No. 52237-03-3);

benzenesulfonic acid, 5-(2H-naphtho[1,2-d]triazol-2-yl)-2-(2-phenylethenyl)-, sodium salt, also known as Pylaklor White S-15A (CAS Registry No. 6416-68-8);

1,3,6,8-pyrenetetrasulfonic acid, tetrasodium salt (CAS Registry No. 59572-10-0);

pyranine, (CAS Registry No. 6358-69-6, aka 8-hydroxy-1,3,6-pyrenetrisulfonic acid, trisodium salt);

quinoline (CAS Registry No. 91-22-5);

3H-phenoxazin-3-one, 7-hydroxy-, 10-oxide, also known as Rhodalux (CAS Registry No. 550-82-3);

xanthylium, 9-(2,4-dicarboxyphenyl)-3,6-bis(diethylamino)-, chloride, disodium salt, also known as Rhodamine WT (CAS Registry No. 37299-86-8);

phenazinium, 3,7-diamino-2,8-dimethyl-5-phenyl-, chloride, also known as Safranine O (CAS Registry No. 477-73-6);

C.I. Fluorescent Brightener 235, also known as Sandoz CW (CAS Registry No. 56509-06-9);

benzenesulfonic acid, 2,2′-(1,2-ethenediyl)bis[5-[[4-[bis(2-hydroxyethyl)amino]-6-[(4-sulfophenyl)aminol-1,3,5-triazin-2-yl]amino]-, tetrasodium salt, also known as Sandoz CD (CAS Registry No. 16470-24-9, aka Flu. Bright. 220);

benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, also known as Sandoz TH-40 (CAS Registry No.32694-95-4);

xanthylium, 3,6-bis(diethylamino)-9-(2,4-disulfophenyl)-, inner salt, sodium salt, also known as Sulforhodamine B (CAS Registry No. 3520-42-1, aka Acid Red 52);

benzenesulfonic acid, 2,2′-(1,2-ethenediyl)bis[5-[[4-[(arninomethyl)(2-hydroxyethyl)amino]-6-(phenylamino)-1,3,5-triazin-2-yl]amino]-, disodium salt, also known as Tinopal 5BM-GX (CAS Registry No. 169762-28-1);

Tinopol DCS (CAS Registry No. 205265-33-4);

benzenesulfonic acid, 2,2′-([1,1′-biphenyl]-4,4′-diyldi-2,1-ethenediyl)bis-, disodium salt, also known as Tinopal CBS-X (CAS Registry No. 27344-41-8);

benzenesulfonic acid, 5-(2H-naphtho[1,2-d]triazol-2-yl)-2-(2-phenylethenyl)-, sodium salt, also known as Tinopal RBS 200, (CAS Registry No. 6416-68-8);

7-benzothiazolesulfonic acid, 2,2′-(1-triazene-1,3-diyldi-4,1-phenylene)bis[6-methyl-, disodium salt, also known as Titan Yellow (CAS Registry No. 1829-00-1, aka Thiazole Yellow G); and

all ammonium, potassium and sodium salts thereof, and all like agents and suitable mixtures thereof.

More preferred inert fluorescent tracers include 1,3,6,8-pyrenetetrasulfonic acid tetrasodium salt (CAS Registry No. 59572-10-0); 1,5-naphthalenedisulfonic acid disodium salt (hydrate) (CAS Registry No. 1655-29-4, aka 1,5—NDSA hydrate); xanthylium, 9-(2,4-dicarboxyphenyl)-3,6-bis(diethylamino)-, chloride, disodium salt, also known as Rhodamine WT (CAS Registry No. 37299-86-8); 1-deoxy-1-(3,4-dihydro-7,8-dimethyl-2,4-dioxobenzo[g]pteridin-10(2H)-yl)-D-ribitol, also known as Riboflavin or Vitamin B2 (CAS Registry No. 83-88-5); fluorescein (CAS Registry No. 2321-07-5); fluorescein, sodium salt (CAS Registry No. 518-47-8, aka Acid Yellow 73, Uranine); 2-anthracenesulfonic acid sodium salt (CAS Registry No. 16106-40-4); 1,5-anthracenedisulfonic acid (CAS Registry No. 61736-91-2) and salts thereof; 2,6-anthracenedisulfonic acid (CAS Registry No. 61736-95-6) and salts thereof; 1,8-anthracenedisulfonic acid (CAS Registry No. 61736-92-3) and salts thereof; and mixtures thereof. The fluorescent tracers listed above are commercially available from a variety of different chemical supply companies. The most preferred inert fluorescent tracer compound is 1,3,6,8-pyrenetetrasulfonic acid, sodium salt.

The composition including the inert fluorescent tracer is prepared by adding sufficient inert fluorescent tracer such that the concentration of inert fluorescent tracer in the mining pond is from about 5 ppt to about 1,000 ppm, preferably from about 1 ppb to about 50 ppm, and more preferably from about 5 ppb to about 50 ppb. The preferred amount of inert fluorescent tracer compound added, within this range may be readily determined by one of ordinary skill in the art, taking into consideration the characteristics of the mined solids being treated and the dimensions and flow patterns into, within, and out of the pond system.

One or more fluorometers are used to detect the fluorescent signal of the inert fluorescent tracer in the slurry in the pond. Suitable fluorometers are selected from the group comprising the TRASAR® 3000 fluorometer, the TRASAR® 8000 fluorometer and the TRASAR® XE-2 Controller, which includes a fluorometer with integrated controller (all available from Nalco® Company in Naperville, Ill.); the Hitachi F-4500 fluorometer (available from Hitachi through Hitachi Instruments Inc. in San Jose, Calif.); the JOBIN YVON FluoroMax-3 “SPEX” fluorometer (available from JOBIN YVON Inc. of Edison, N.J.); and the Gilford Fluoro-IV spectrophotometer or the SFM 25 (available from Bio-tech Kontron through Research Instruments International of San Diego, Calif.). It should be appreciated that this fluorometer list is not comprehensive and is intended only to show examples of fluorometers. Other commercially available fluorometers and modifications thereof can also be used in this invention.

After the fluorometer has been used to detect the fluorescent signal of the inert fluorescent tracer in the slurry in the pond then the detected fluorescent signal can be converted into the actual concentration of inert fluorescent tracer using well known standards that show what the detected fluorescent signal is for a specific amount of a specific inert fluorescent tracer. Because the inert fluorescent tracer is added to the mining pond in a known proportion to the chitosan-containing composition, by detecting the fluorescent signal of the inert fluorescent tracer it is possible to calculate the amount of chitosan present in the mining pond. This enables the operator to determine whether the correct amount of chitosan is present and even to determine where it is present. If desired, adjustments to the operating conditions of the mining pond can be made to ensure an effective amount of chitosan is present in the system.

### EXAMPLES

The foregoing may be better understood by reference to the following examples, which are intended for illustrative purposes and are not intended to limit the scope of the invention.

### Example 1

This Example demonstrates the synergistic effect of blending various amounts of citric acid and sodium bicarbonate with chitosan. Each sample included two components. The first component was chitosan in flake form that was ground and sized through a 30-mesh cloth or screen to about 600 microns. The second component was a 50/50 weight percent mixture of citric acid and sodium bicarbonate. A dry mixture of the two components was prepared in various ratios (see Table 1 below) by rotating the mixture for about 15 minutes. 5-gram pellets of each ratio were made using about 3 tons of pressure for 20 seconds on a hydraulic press. Though any type of press may be used to form the pellet, in this Example a Carver® Benchtop press was used (Carver Inc., Wabash, Ind.).

Each pellet was placed into a beaker having 900 ml of deionized water. Conductivity (measured in μS) was set at zero for the deionized water and was continuously monitored for each sample over the periods indicated in Table 1. Higher conductivity indicated more chitosan in solution and thus a faster dissolution rate. It was observed that chitosan by itself was highly resistant to dissolving in the deionized water—even at the 25-hour time point (not shown), pure chitosan was neither dissolved nor dispersed. The various ratios of incorporated solid citric acid/bicarbonate showed a synergistic effect and a dramatic increase in chitosan dissolution rate. All percentages in Table 1 are weight percent, based on solids in the pellet. In all samples with an acid and bicarbonate component, the pellet was essentially dissolved or dispersed by the 3 min time point.

TABLE 1

| | 15 | | | | | |
|---|---|---|---|---|---|---|
| Sample | sec. | 30 sec. | 1 min. | 1.5 min. | 2 min. | 3 min. |
| 100% chitosan | 0 μS | 0 | 0 | 0 | 0 | 0 |
| 25% citric acid | 0.03 | 0.03 | 0.07 | 0.10 | 0.09 | 0.09 |
| 25% NaHCO₃ | | | | | | |
| 50% chitosan | | | | | | |
| 10% citric acid | 0 | 0.01 | 0.02 | 0.02 | 0.03 | 0.07 |
| 10% NaHCO₃ | | | | | | |
| 80% chitosan | | | | | | |
| 5% citric acid | 0 | 0.01 | 0.02 | 0.02 | 0.02 | 0.02 |
| 5% NaHCO₃ | | | | | | |
| 90% chitosan | | | | | | |

### Example 2

The samples in this Example were treated the same as those in Example 1, the difference being the citric acid was replaced with ascorbic acid. The synergistic effect on the chitosan dissolution rate is not as strong as with citric acid, but still evident. As above, in all samples with an acid and bicarbonate component, the pellet was essentially dispersed or dissolved by the 3 min time point. Results are shown in Table 2 below.

TABLE 2

| | 15 | 30 | | | | |
|---|---|---|---|---|---|---|
| Sample | sec. | sec. | 1 min. | 1.5 min. | 2 min. | 3 min. |
| 100% chitosan | 0 μS | 0 | 0 | 0 | 0 | 0 |
| 25% ascorbic acid | 0.01 | 0.02 | 0.02 | 0.03 | 0.02 | 0.03 |
| 25% NaHCO₃ | | | | | | |
| 50% chitosan | | | | | | |
| 10% ascorbic acid | 0 | 0 | 0.01 | 0.01 | 0.01 | 0.02 |
| 10% NaHCO₃ | | | | | | |
| 80% chitosan | | | | | | |
| 5% ascorbic acid | 0 | 0.01 | 0.01 | 0.01 | 0.02 | 0.02 |
| 5% NaHCO₃ | | | | | | |
| 90% chitosan | | | | | | |

### Example 3

This Example demonstrated the synergistic clarification of a dredging slurry with added chitosan or added chitsoanlsilica sol mixture. The chitosan was a solution of about 2 weight percent and the silica sol was a solution of about 26 weight percent (N-1056, available from Nalco® Company in Naperville, Ill.). Sample A included adding 1 ml of the chitosan solution to the dredging slurry. In Sample B, 1 ml of the chitosan solution and 5 drops of the silica sol solution were separately added to the dredging slurry. A blend of 9/1 chitosan solution/silica sol solution (by volume) was used in Sample C. In each sample, the chitosan/silica was added to a 250 ml graduated cylinder having a fresh 250 ml aliquot of the dredging slurry. In Table 3 below, Column 2 shows the observed settling rate (inches per minute) and Column 3 shows NTU (nephelometric turbidity units) measured after 10 minutes of exposure to the respective mixture.

TABLE 3

| | | Settling Rate | |
|---|---|---|---|
| Sample | | (in/min) | NTU |
| A: | 1 ml Chitosan | 3.2 | 72 |
| B: | 1 ml Chitosan | 2.8 | 60 |
| | 5 drops N-1056 | | |
| C: | 1 ml 9/1 Blend | 2.6 | 64 |

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

The claimed invention is:

1. A solid composition for dosing a solid-liquid separation system with chitosan to agglomerate suspended solids in said system, said composition comprising a first component including chitosan and a second component including a solid acid and a carbonate source and/or a bicarbonate source, the second component characterized by enhancing a dissolution rate of the chitosan and having a ratio of about 1:4 to about 4:1 of the solid acid to the carbonate source and/or the bicarbonate source.

2. The solid composition of claim 1, wherein the solid-liquid separation system is a mining or mineral pond system.

3. The solid composition of claim 1, wherein the solid-liquid separation system is selected from the group consisting of: woven and composite filter media, nonwoven filter media, membranes, clarification filtration, sedimenters, cake filters, centrifugal separations, pressure filtration, and vacuum filtration.

4. The solid composition of claim 1, including about 5 to about 95 weight percent of the first component.

5. The solid composition of claim 1, wherein the solid acid is selected from the group consisting of: citric acid, ascorbic acid, and combinations thereof

6. The solid composition of claim 1, wherein the solid acid is selected from the group consisting of: an organic acid, a carboxylic acid, a biological acid, and combinations thereof.

7. The solid composition of claim 1, wherein the carbonate source and/or bicarbonate source includes an alkali or alkaline earth metal.

8. The solid composition of claim 1, including about a 1:1 ratio of the solid acid to the carbonate source and/or the bicarbonate source.

9. The solid composition of claim 1, wherein the ratio is either a weight ratio or a molar ratio.

10. The composition of claim 1, including an effective amount of a siliceous material.

11. The solid composition of claim 1, including an inert fluorescent tracer.

12. A method of agglomerating solids in a solid-liquid separation system, the method comprising forming a solid composition according to claim 1 and controllably dosing said system with the solid composition.

13. The method of claim 12, including dosing the system with an amount of the solid composition such that about 0.01 pounds to about 100 pounds chitosan per ton dry solids is present in the water in the system.

14. The method of claim 12, wherein said system is a mining or mineral processing pond system.

15. The method of claim 14, wherein said pond system includes only one pond.

16. The method of claim 14, wherein said pond system includes a plurality of ponds.

17. The method of claim 14, wherein said pond system includes a plurality of ponds and less than the plurality is dosed with the solid composition.

18. The method of claim 14, wherein said pond system includes a plurality of ponds and each pond is dosed with the solid composition.

19. The method of claim 14, wherein said pond system includes a plurality of ponds and the dose of the solid composition is individually adjusted for each pond.

20. The method of claim 12, further comprising:
(a) adding an inert fluorescent tracer to the solid composition or to the system in conjunction with the solid composition;
(b) using one or more fluorometers to detect a fluorescent signal of the inert fluorescent tracer;
(c) determining an amount of the fluorescent tracer that is present in the system;
(d) calculating an amount of the chitosan present in the system based on the amount of the fluorescent tracer that is present in the system; and
(e) optionally adjusting said dose of the solid composition to ensure a desired amount of chitosan is present in the system.

21. The method of claim 12, wherein the solid-liquid separation system is selected from the group consisting of: woven and composite filter media, nonwoven filter media, membranes, clarification filtration, sedimenters, cake filters, centrifugal separations, pressure filtration, and vacuum filtration.
